(19) United States
(12) Patent Application Publication
(10) Pub. No.: US 2008/0217422 A1
(43) Pub. Date: Sep. 11, 2008

(54) Nozzle assembly, delivery system and method for conveying insulation material

(76) Inventor: Daniel Elden Near, Littleton, CO (US)

Correspondence Address: JOHNS MANVILLE, 10100 WEST UTE AVENUE, PO BOX 625005, LITTLETON, CO, 80162-5005, US

(21) Appl. No.: 11/716,136

(22) Filed: Mar. 9, 2007

(51) Int. Cl. A62C 5/02

(52) U.S. Cl. 239/8

(57) ABSTRACT

A method of conveying particles of insulation material suspended in a flow of air to a wall, floor or ceiling cavity to form an insulation product in the cavity, including: providing a flow of particles of insulation material suspended in air to a nozzle assembly; and positioning the nozzle assembly to direct the flow of particles of insulation material suspended in air to a wall, floor or ceiling cavity defined by adjacent elongated supporting members such that at the point of contact between the flow and the wall, floor or ceiling cavity, the flow has a flow dispersion pattern that is at least as wide as the distance between the adjacent elongated supporting members.

### BACKGROUND

Loose fill fibrous insulation can be blown or pumped into attics, walls and other surfaces of houses and other buildings. The loose fill fibrous insulation can include inorganic material such as fiberglass and/or organic material such as cellulose fibers. A binder can be added to the fibrous insulation as it is emitted from a nozzle to bind the insulation particles together.

In conventional methods and systems, the fibrous insulation is blown into a cavity defined between two adjacent elongated supporting members such as studs or purlins by directing a flow of the fibrous insulation into the cavity. In such conventional methods and systems, it is necessary to adjust the insulation flow both in a direction perpendicular to the elongated supporting members as well as in a direction parallel to the elongated supporting members in order to adequately fill the cavity with the insulation material.

This conventional technique and system of filling the cavity presents several drawbacks. For example, when the insulation flow is directed back and forth in a direction perpendicular to the elongated supporting members, the flow typically impacts the supporting members, causing build-up of the insulation material on the supporting members and/or fly off of the insulation material from the supporting members. Such build-up can adversely affect the user's ability to determine the endpoint of the filling of the cavity, and as such, overfilling of the cavity can occur. In addition, the fly off of the insulation material can result in wasted materials, and in particular the use of excess binder. Further, the conventional techniques and systems that require both parallel and perpendicular directional adjustments of the insulation flow can be prone to a relatively high degree of user error and/or fatigue during the installation process, since it is necessary for the user to make frequent nozzle position adjustments.

In addition, conventional techniques and systems generally do not provide adequate means for controlling the density of the blown-in insulation. The installation of blown-in insulation having a density that is higher than what is required for a specific application can result in the use of excess insulation and binder material, which can in turn contribute to increased installation costs.

Furthermore, because specific parameters of the blowing process such as temperature, humidity, the particle size and consistency of the loose fill fibrous insulation, the blowing machine settings, etc. can vary from site to site, it can be difficult in conventional techniques and systems to attain a desirable flow pattern emitted from the blowing nozzle, and to obtain a desired density of the blown-in insulation product.

### SUMMARY

According to one aspect, a method of conveying particles of insulation material suspended in a flow of air to a wall, floor or ceiling cavity to form an insulation product in the cavity is provided, comprising:

providing a flow of particles of insulation material suspended in air to a nozzle assembly; and

positioning the nozzle assembly to direct the flow of particles of insulation material suspended in air to a wall, floor or ceiling cavity defined by adjacent elongated supporting members such that at the point of contact between the flow and the wall, floor or ceiling cavity, the flow has a flow dispersion pattern that is at least as wide as the distance between the adjacent elongated supporting members.

According to another aspect, a nozzle assembly for conveying a flow of particles of insulation material suspended in air to a substrate to form an insulation product on the substrate is provided, comprising:

a nozzle body defining a flow path for accommodating the flow of particles of insulation material suspended in air, wherein the nozzle body comprises an inlet for receiving the flow of particles of insulation material suspended in air; an outlet for propelling the flow from the nozzle assembly, wherein the ratio of the width of the outlet to the width of the inlet is at least about 1.5:1; and

at least one binder outlet for providing a binder to the flow of particles of insulation material propelled from the outlet.

According to another aspect, a nozzle assembly for conveying a flow of particles of insulation material suspended in air to a substrate to form an insulation product on the substrate is provided, comprising:

a nozzle body defining a flow path for accommodating the flow of particles of insulation material suspended in air, wherein the nozzle body comprises an inlet for receiving the flow of particles of insulation material suspended in air; and an outlet for propelling the flow from the nozzle assembly;

at least one binder outlet for providing a binder to the flow of particles of insulation material propelled from the outlet; and

a device for adjusting the profile of the outlet of the nozzle body.

According to another aspect, a method of controlling the density of a blown-in insulation product is provided, comprising selecting (1) a distance between a nozzle assembly emitting a flow of particles of insulation material suspended in air, and a substrate on which the insulation product is formed, (2) a flow rate of the particles of insulation material, and (3) an outlet profile of the nozzle assembly, that are effective when employed together to obtain a blown-in insulation product having a thermal resistivity of from about R-3 to R-5 per inch.

According to another aspect, a method of forming a blown-in insulation product is provided, comprising directing a flow of particles of insulation material suspended in air emitted from a nozzle assembly at a substrate, wherein the nozzle assembly is structured such that the flow emitted therefrom forms an insulation product on the substrate having a thermal resistivity of from about R-3 to R-5 per inch, wherein the flow emitted from the nozzle assembly is effective to minimize the density of the blown-in insulation product while maintaining the thermal resistivity of from about R-3 to R-5 per inch.

### BRIEF DESCRIPTION OF THE DRAWINGS

FIG. 1 is a perspective view of an exemplary nozzle assembly according to one aspect.

FIG. 2 is a partial front view of an exemplary nozzle assembly according to an additional aspect.

FIG. 3 is a partial side view of an exemplary nozzle assembly according to an additional aspect.

### DETAILED DESCRIPTION

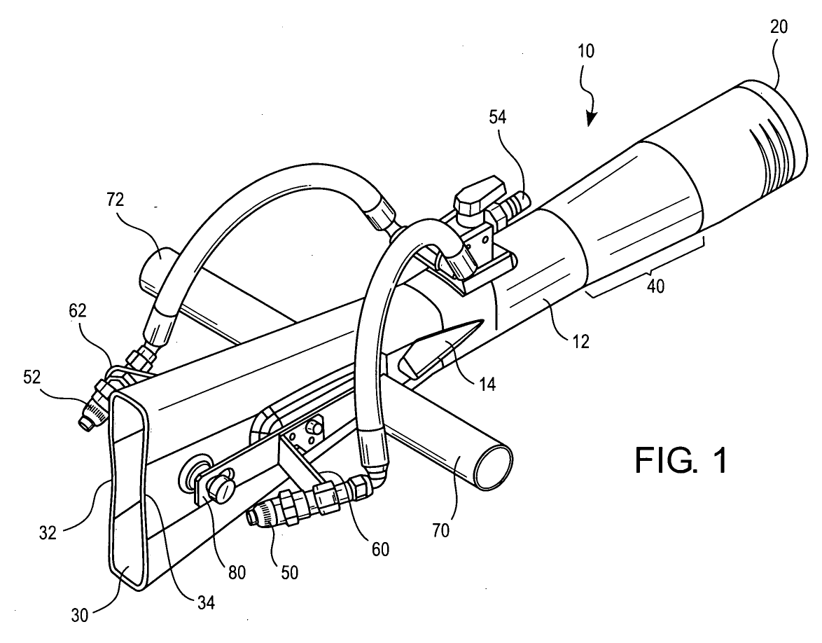

Referring to FIG. 1, a nozzle assembly 10 is provided for accommodating a flow of insulation particles suspended in air. The nozzle assembly 10 includes a nozzle body 12 having an inlet 20 for receiving a flow of insulation particles suspended in air, an intermediate section 40, and an outlet 30 for propelling the flow from the nozzle assembly 10. The nozzle body 12 defines a flow path through which the flow of insulation particles suspended in air passes. The nozzle body 12 can be formed from any suitable material for accommodating the flow of insulation particles suspended in air, and can be formed from, for example, a moldable plastic material. Preferably, the material forming the nozzle body 12 can be a rigid yet flexible material.

The inlet 20 can be connected to receive the flow of insulation particles suspended in air from a conduit such as a flexible blow hose, which can in turn be in communication with a source of insulation particles such as a blowing machine. The flow can pass through the flow path of the nozzle body 12 and be propelled from the outlet 30 of the nozzle assembly 10 at a substrate on which the insulation is to be formed.

The substrate can include any conventional surface on which insulation can be formed such as, for example, oriented strand board (“OSB”), plywood, hardboard, natural lumber, metal studs, metal decking, poured concrete, prefabricated concrete, spray-applied or rigid foam insulation, foam or fiberboard vent chutes, plastic vent chutes, and other products known in the construction art that are installed as a part of a building prior to the installation of insulation materials. For example, a wall, floor or ceiling cavity can constitute the space defined between two adjacent elongated supporting members such as, for example, studs or purlins. A backing surface arranged between the elongated supporting members can constitute the substrate on which the insulation material is formed. The elongated supporting members are preferably arranged substantially parallel to each another, and can be spaced any distance apart, for example, in accordance with the structural requirements of the facility to be insulated. For example, the distance between adjacent elongated supporting members can be about 16 inches on center or about 24 inches on center, which are standard distances employed in the industry.

The intermediate section 40 of the nozzle body 12 is disposed downstream from the inlet 20, and can be disposed either a distance from the outlet 30 or can extend to the outlet 30. The intermediate section 40 can have a shape that is effective to change the flow characteristics of the flow of insulation particles, which can in turn have an effect on the density of the insulation formed on the substrate. In an exemplary embodiment, the cross-sectional area of the flow path at an inlet of the intermediate section 40 is greater than the cross-sectional area of the flow path at an outlet of the intermediate section 40, and the cross-sectional area of the flow path does not increase from the inlet of the intermediate section 40 to the outlet of the intermediate section 40. That is, in this exemplary embodiment, the cross-sectional area of the flow path through the intermediate section 40 does not expand at any point therein. For example, the cross-sectional area of the flow path through the intermediate section 40 can constantly decrease in the direction of the outlet 30. In an exemplary embodiment, the cross-sectional area taken at any point of the intermediate section 40 is less than the cross sectional area of the inlet 20 of the nozzle body 12.

The intermediate section 40 can constitute an amount of the total length of the nozzle assembly 10 that is effective to impart desirable flow characteristics such as, for example, at least about 10%, more preferably at least about 15%, more preferably from about 15% to about 85%, and even more preferably from about 20% to about 80% of the total length of the nozzle assembly 10. Multiple intermediate sections 40 can also be employed in the nozzle body 12. The intermediate section 40 can, for example, have a structure that is effective to increase the velocity of a flow of air passing there through.

The nozzle assembly 10 can have any overall dimensional and weight specifications that are suitable for use with an insulation blowing system, and preferably the nozzle assembly 10 is sufficiently compact and lightweight to facilitate use by hand. For example, the nozzle assembly 10 can have an overall length of from about 12 inches to about 26 inches, more preferably from about 18 inches to about 20 inches.

The inlet 20 of the nozzle assembly 10 can have any diameter that is suitable for receiving the flow of insulation particles from a conduit conveying such flow such as a flexible blowing hose. For example, the inlet 20 can have a diameter that is substantially the same as the diameter of the conduit which provides such flow. For example, the inlet 20 can have a diameter of from about 2 inches to about 4 inches, more preferably about 3 inches.

The outlet 30 of the nozzle assembly 10 can have a shape that is suitable for propelling the flow of insulation particles suspended in air to the substrate. Preferably, the outlet 30 can have a substantially wide and flat cross-sectional profile. For example, the outlet 30 can have a substantially rectangular or elliptical shape, but is not limited to such shapes. In a preferred embodiment, the outlet 30 can have a substantially rectangular shape which can facilitate the even distribution of the insulation particles in the flow pattern of the flow propelled from the outlet 30. In the case where a substantially rectangular shape is employed, the corners of such profile can be rounded, and indentations 32, 34 can exist along either or both of the elongated sides of the outlet 30 in order to promote flow towards the outer lateral edges of the outlet 30.

The outlet 30 of the nozzle assembly 10 can have a substantially higher width to height ratio in comparison with conventional nozzles. For example, the outlet 30 can have a width of from about 5 inches to about 8 inches, more preferably from about 6 inches to about 7 inches, and a height of from about 0.5 inch to about 1 inch, more preferably from about 0.6 inch to about 0.8 inch. If the width is excessively narrow, it can impede the particle flow through the outlet 30, and an excessively broad width can have an adverse effect on the flow pattern characteristics. The dimensions of the outlet 30 can depend on, for example, the dimensions of the substrate to be insulated and/or the size of the insulation particles intended to be used.

In a preferred embodiment, the outlet 30 preferably can have a width that is substantially greater than the width of the inlet 20 of the nozzle assembly 10. As used herein, the term “width of the outlet” as it relates to the outlet 30 refers to the maximum dimension of the outlet 30. The term “width of the inlet” as it relates to the inlet 20 refers to the maximum dimension of the inlet 20. In the case where the inlet 20 is substantially circular in shape, the width of the inlet 20 corresponds to the diameter of the inlet 20. For example, the ratio of the width of the outlet 30 to the width of the inlet 20 can be at least about 1.5:1, preferably from about 1.5:1 to about 5:1, more preferably from about 1.8:1 to about 4:1, and most preferably from about 2:1 to about 3:1.

By passing the flow of insulation particles through the nozzle assembly 10, the density of the insulation formed on the substrate can be controlled to achieve a thermal resistivity of, for example, from about R-3 to R-5 per inch, preferably from about R-3.5 to R-4.5 per inch, and more preferably about R-4.2 per inch of insulation product. For example, for a standard 2×4 cavity, the thermal resistivity can be about R-15. Applicants have observed that when using an insulation material comprising fiberglass particles, an average blown-in insulation density of about 1.8 PCF can be sufficient to achieve the desired R-values, and that substantially higher average densities (such as an average insulation density as high as about 2.5 PCF) do not necessarily result in an increased R-value. As such, by employing the nozzle assembly 10 having the structural characteristics described above, the desired insulation specification can be achieved while maintaining the average density at a desirable level such, for example, from about 1.8 to about 2.0 PCF, more preferably about 1.8 PCF, thereby minimizing unnecessary costs associated with the use of excess materials.

By employing a nozzle assembly 10 having the above structure, the flow dispersion pattern, i.e., the shape of the flow of the insulation particles suspended in air that is emitted from the outlet 30, is substantially widened and flattened, thereby improving the contact between the binder emitted from the at least one binder outlet 50, 52 and the propelled insulation particles. Conventional nozzles have outlet profiles that are not as wide and flat, which generally result in a lesser degree of contact between the binder and the insulation particles, and the use of such conventional nozzles can require an increase of the binder flow velocity to attain adequate binder-particle contact. Use of an exemplary embodiment of the nozzle assembly 10, on the other hand, can mitigate or obviate such problems by providing the aforementioned widened and flattened flow dispersion pattern. For example, as described above, the outlet 30 of the nozzle assembly 10 can have a cross-sectional profile that is substantially wider than the cross-sectional profile of the conduit such as a blow hose that is connected in fluid communication upstream from the nozzle assembly 10.

In an exemplary embodiment, the outlet 30 can provide an insulation flow that has an adequate level of lateral particle dispersion, for example, such that the flow has a substantially uniform density wherein the density of the insulation particles is not substantially higher at the center of the flow dispersion pattern in comparison with the lateral edges of the flow dispersion pattern. For example, at least one obstruction 14 can be arranged at the center of the flow path of the nozzle assembly 10 that is capable of diverting some of the flow of insulation particles to either side of the obstruction 14, thereby increasing the uniformity of the density of the flow at the outlet 30. The at least one obstruction 14 can be, for example, a protrusion disposed on the inner surface of the nozzle assembly 10, and can be arranged at any effective position in the nozzle assembly 10 upstream from the outlet 30, and is preferably arranged downstream from the intermediate section 40. Preferably, two protrusions 14 (other not shown) can be arranged on opposite sides of the interior surface of the nozzle assembly 10, and substantially at the center of the flow path. The optional indentations 32, 34 discussed above can also contribute to providing a more uniform flow of particles.

The nozzle assembly 10 can include at least one binder outlet 50 for providing a binder flow to the particles of insulation material propelled from the outlet 30. For example, the at least one binder outlet 50 can provide a flow of liquid binder preferably in the form of a jet or spray to the flow of insulation particles that is emitted from the outlet 30. In a preferred embodiment, the nozzle assembly 10 includes two binder outlets 50, 52 for spraying the binder on the particles of insulation material, a first binder spray outlet 50 being arranged at one elongated side of the outlet 30 of the nozzle assembly 10 and a second binder outlet 52 being arranged at the opposite elongated side of the outlet 30. An exemplary spray jet that can be used is a 65 degree flat spray nozzle available from Spray-Tec Inc. located in Shelbyville, Ky.

The at least one binder outlet 50, 52 is preferably adjustably mounted to the exterior of the nozzle assembly 10 by an adjustable mount 60, 62 such that the position of the at least one binder outlet 50, 52 can be adjusted by the user. The at least one binder outlet 50, 52 can be connected to receive a flow of the binder from a binder conduit in communication with a binder source, via a binder inlet 54.

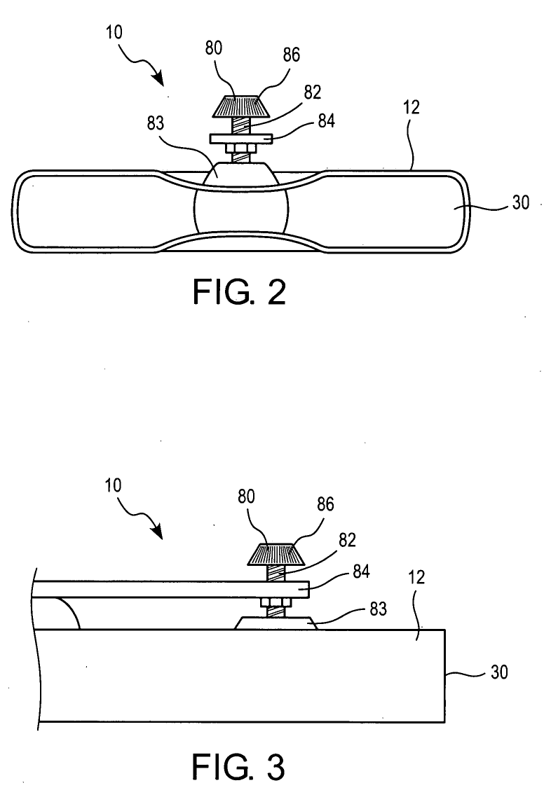

Referring to FIGS. 1-3, in an exemplary embodiment, the nozzle assembly 10 can include a device 80 for adjusting the profile of the outlet 30 of the nozzle body 12. Specific parameters of the blowing process such as temperature, humidity, the particle size and consistency of the loose fill fibrous insulation, the blowing machine settings, etc. can vary from site to site, and the device 80 for adjusting the profile of the outlet 30 can assist the user to obtain a desirable flow dispersion pattern (and density of the blow-in insulation) by allowing the user to increase or decrease the cross-sectional area of the outlet 30 and modify its overall profile. Any device that is capable of adjusting the cross-sectional area and profile of the outlet 30 can be used. For example, in the case where the nozzle body 12 is formed from a flexible material such as a plastic material, the device 80 can adjust the profile of the outlet 30 of the nozzle body 12 by applying and maintaining force to the nozzle body 12.

In an exemplary embodiment, the device 80 can include a screw 82 and a screw support 84 having a threaded aperture for accommodating the screw 82. The screw 82 can, for example, be disposed normal to an elongated side of the nozzle body 12. The screw support 84 can be integral with the nozzle body 12 or can constitute a separate part from the nozzle body 12, for example, a rigid bar 84. An end of the screw 82 can have a flange (not shown) that engages with a flange retainer 83. By tightening the screw 82, i.e., inducing the screw travel towards the nozzle body 12, the flange of the screw 82 can exert force against the nozzle body 12 thereby compressing the outlet profile. On the other hand, when the screw 82 is loosened, i.e., when the screw travel is induced away from the nozzle body 12, the flange can pull on flange retainer 83 thereby expanding the nozzle body 12 and the outlet profile. The device 80 can include a knob 86 for facilitating adjustment of the position of the screw 82. In an alternative embodiment, the nozzle assembly 10 can include two devices 80, one at each elongated side of the outlet 30.

In light of the various parameters of the insulation blowing system such as, for example, the settings of the blowing machine, the diameter of the blowing hose, and the dimensions of the insulation particles, as well as the potential varying temperature and humidity conditions, it can be beneficial to provide the user with the ability to adjust the profile of the outlet 30 of the nozzle assembly 10. It can also be beneficial to provide the ability to adjust the profile of the outlet 30 in real time, for example, to make fine adjustments during the blowing process. By use of the device 80, the profile and cross-sectional area of the outlet 30 can be adjusted on-site and even during the installation of the blown-in insulation, providing the user with the ability to adjust the flow dispersion pattern (and the density of the blown-in insulation material) in real time.

According to another aspect, a method of conveying particles of insulation material suspended in a flow of air to a wall, floor or ceiling cavity, can be employed. A flow of particles of insulation material suspended in air is provided to, for example, the nozzle assembly 10 described above. The flow can be provided via a conduit such as, for example, a flexible blow hose. The conduit can be any suitable length that enables convenient on-site use of the system, and the conduit preferably has a diameter that allows for good flow characteristics of the insulation particles through the conduit. For example, the diameter of the conduit can be from about 2 inches to about 4 inches, preferably about 3 inches. An end of the conduit can be attached to the inlet 20 of the nozzle assembly 10.

Any blowing machine suitable for blowing insulation particles can be used to generate the flow of insulation particles suspended in air. For example, the insulation particles can be fed to a conventional insulation blowing machine that entrains such particles in a rapidly moving air stream that exits the blowing machine via a flexible blowing hose. A typical blowing machine is a Unisul Volu-Matic machine available from Unisul Company located in Winter Haven, Fla.

The nozzle assembly 10 can be positioned to provide the flow of insulation particles suspended in air to the substrate on which the insulation material is to be formed, for example, a wall, floor or ceiling cavity. The nozzle assembly 10 can be positioned by hand and can include at least one handle 70, 72 to assist the positioning of the assembly 10. The nozzle assembly 10 can be positioned such that at the point of contact between the flow and the wall, floor or ceiling cavity, the flow has a flow dispersion pattern that is at least as wide as the distance between adjacent elongated supporting members in the wall, floor or ceiling cavity. The flow dispersion pattern at the point of contact with the substrate can generally depend on the settings of the blowing machine, the type and shape of insulation particles employed, the shape of the nozzle assembly, and the distance of the nozzle assembly to the substrate. In an exemplary embodiment, these factors can be adjusted to attain a flow dispersion pattern that is at least as wide as the distance between adjacent studs in the wall, floor or ceiling cavity, at the point of contact between the flow and the wall, floor or ceiling cavity. This can provide advantages such as reducing build-up of the insulation material on the elongated supporting members and/or fly off of the insulation material from the elongated supporting members, thereby facilitating the installation process.

The wall, floor or ceiling cavity can constitute the space between adjacent elongated supporting members such as, for example, studs or purlins. The distance between such elongated supporting members can depend on the specific application, for example, whether the substrate to be insulation is in a residential or commercial building. For example, the distance between elongated supporting members can be from about 12 inches on center and about 30 inches on center. In exemplary embodiments, standard distances between elongated supporting members that can be used are 16 inches on center and/or 24 inches on center.

During the installation process, the direction of the flow in insulation particles suspended in air propelled from the outlet 30 can be controlled by adjusting the position of the nozzle assembly 10. Preferably, the direction of the flow can be adjusted in a direction substantially parallel to the elongated supporting members, in order to fill the cavity with the insulation material. For example, the cavity can be filled with one or multiple passes of the flow of insulation particles in a direction that is substantially parallel to the elongated supporting members. In an exemplary embodiment, the nozzle assembly 10 is effective to emit a flow dispersion pattern that spans at least the width of the distance between adjacent elongated supporting members. Thus, for example, during the filling of a cavity, the direction of the flow need not be adjusted substantially in a direction perpendicular to the elongated supporting members and is preferably only adjusted substantially in the parallel direction. The outlet 30 of the nozzle assembly 10 can be positioned at a distance from the substrate that allows for the efficient filling of the cavity, for example, from about 18 inches to about 30 inches, more preferably from about 22 inches to about 28 inches, and most preferably about 24 inches.

The insulation material used to form the insulation particles can be formed from any suitable insulation material, and preferably includes inorganic fibers. The inorganic fibers can include fiberglass, slag wool, mineral wool, rock wool, ceramic fibers and carbon fibers. Additionally or alternatively, organic fibers such as cellulose fibers can be included in an exemplary embodiment. The average fiber diameter of the fibers can be, for example, about 6 microns or less, more preferably less than about 3 microns or less, and even more preferably about 2 microns or less. The insulation particles can be any suitable size, for example, such particles can have an average diameter of about 0.5 inch, or smaller, more preferably about 0.25 inches. The particles are preferably mostly smaller than one-half inch in diameter, but larger sizes can be used. The insulation material can optionally contain a substantially dry binder material prior to being blown, for example, a thermoset resin, that is activatable upon contact with the binder. Thus, the liquid binder ejected from the at least one binder outlet 50, 52 of the nozzle assembly 10 can be water which activates the dry binder material present in the insulation material. The insulation material can contain additives such as infrared barrier agents, anti-static agents, anti-fungal agents, biocides, de-dusting agents, pigments, colorants, etc., or one or more of these functional ingredients can be applied to the fibers either before or during processing in the hammer mill or other reducing device.

The liquid binder that can be used with the nozzle assembly 10 can include any material that is effective to bind the insulation particles together to form the insulation product. For example, the liquid binder can contain a binder material and/or the liquid binder can function as an activator for a dry binder material present in the flow of insulation particles. In an exemplary embodiment, depending on the particular insulation particles and additives employed therewith, the liquid binder can constitute water.

For example, the liquid binder can be made up by adding the proper amount of water to a tank and then adding the proper amount of a resin, preferably a concentrated solution of the resin, to the water in the tank while optionally stirring to insure proper mixing. If a powdered resin is used, more time and stirring can be required to obtain the solution. Also, particularly when the water in the tank is cool, it may be advantageous to heat the water to at least room temperature before adding the resin. Numerous water-soluble resins can be used in the present invention. An exemplary resin for use in the present invention is a water soluble partially hydrolyzed polyester oligomer such as S-14063 and SA-3915 available from Sovereign Specialty Chemicals of Greenville, S.C. This resin can be diluted to a lower concentration when added to the water in a mixing and using tank, preferably to a concentration of less than 15 percent and most typically to about 11.5 percent. An adjustable rate pump connected to the use tank can supply the aqueous adhesive at the desired rate and pressure to the binder outlet through one or more flexible hoses to properly coat the insulation particles with the desired amount of liquid binder.

The insulation particles can be produced by running mineral fiber insulation such as virgin glass fiber insulation or fiber glass insulation containing a cured binder through a hammer mill, slicer-dicer or other device for reducing material to small particles. For example, a slicer-dicer cuts or shears blankets of fibrous insulation into small cube-like or other three dimensional pieces while hammer mills tear and shear virgin fiber glass or fiber glass blanket into pieces, letting only pieces below a pre-selected size out of the mill by using an exit screen containing predetermined opening sizes. The size of the openings can be adjusted to produce the desired size of insulation particles, and can be from about one inch to about three inches, and more preferably about 1.25 inches.

While the invention has been described in detail with reference to specific embodiments thereof, it will be apparent to one skilled in the art that various changes and modifications can be made, and equivalents employed without departing from the scope of the claims.

What is claimed is:

1. A method of conveying particles of insulation material suspended in a flow of air to a wall, floor or ceiling cavity to form an insulation product in the cavity, comprising:
providing a flow of particles of insulation material suspended in air to a nozzle assembly; and
positioning the nozzle assembly to direct the flow of particles of insulation material suspended in air to a wall, floor or ceiling cavity defined by adjacent elongated supporting members such that at the point of contact between the flow and the wall, floor or ceiling cavity, the flow has a flow dispersion pattern that is at least as wide as the distance between the adjacent elongated supporting members.

2. The method according to claim 1, wherein the nozzle assembly comprises:
a nozzle body defining a flow path for accommodating the flow of particles of insulation material suspended in air, wherein the nozzle body comprises an inlet for receiving the flow of particles of insulation material suspended in air; an outlet for propelling the flow from the nozzle assembly, wherein the ratio of the width of the outlet to the width of the inlet is at least about 1.5:1; and
at least one binder outlet for providing a binder to the flow of particles of insulation material propelled from the outlet.

3. The method according to claim 2, wherein the ratio of the width of the outlet of the nozzle body to the width of the inlet of the nozzle body is from about 1.5:1 to about 5:1.

4. The method according to claim 2, wherein the outlet of the nozzle body has a width of from about 5 inches to about 8 inches, and the inlet of the nozzle body has a width of from about 0.5 inch to about 1 inch.

5. The method according to claim 2, wherein the nozzle assembly comprises two binder outlets for providing the binder to the particles of insulation material, wherein a first binder outlet is arranged at one side of the outlet of the nozzle body and a second binder outlet is arranged at the opposite side of the outlet of the nozzle body.

6. The method according to claim 1, wherein the particles of insulation material comprise glass fibers.

7. The method according to claim 1, wherein the flow of particles of insulation material is provided to the nozzle assembly via a flexible blow hose in communication with an insulation blowing machine.

8. The method according to claim 1, wherein the distance between adjacent elongated supporting members defining the wall, floor or ceiling cavity is from about 12 inches on center to about 30 inches on center.

9. The method according to claim 1, further comprising a step of maintaining the position of the outlet of the nozzle assembly at a distance of from about 18 inches to about 30 inches from the substrate while the flow of insulation particles is provided to the substrate.

10. The method according to claim 1, further comprising a step of filling the wall, floor or ceiling cavity with the insulation material by adjusting the direction of the flow of insulation particles suspended in air, in a direction substantially parallel to the adjacent elongated supporting members which define the wall, floor or ceiling cavity.

11. The method according to claim 10, wherein the wall, floor or ceiling cavity is filled without substantially adjusting the direction of the flow of insulation particles suspended in air, in a direction perpendicular to the adjacent elongated supporting members.

12. A nozzle assembly for conveying a flow of particles of insulation material suspended in air to a substrate to form an insulation product on the substrate, comprising:
a nozzle body defining a flow path for accommodating the flow of particles of insulation material suspended in air, wherein the nozzle body comprises an inlet for receiving the flow of particles of insulation material suspended in air; an outlet for propelling the flow from the nozzle assembly, wherein the ratio of the width of the outlet to the width of the inlet is at least about 1.5:1; and
at least one binder outlet for providing a binder to the flow of particles of insulation material propelled from the outlet.

13. The nozzle assembly according to claim 12, wherein the nozzle body further comprises an intermediate section disposed downstream from the inlet of the nozzle body, wherein the cross-sectional area of the flow path at an inlet of the intermediate section is greater than the cross-sectional area of the flow path at an outlet of the intermediate section, and wherein the cross-sectional area of the flow path does not increase from the inlet of the intermediate section to the outlet of the intermediate section.

14. The nozzle assembly according to claim 12, wherein the ratio of the width of the outlet of the nozzle body to the width of the inlet of the nozzle body is from about 1.5:1 to about 5:1.

15. The nozzle assembly according to claim 12, wherein the outlet of the nozzle body has a width of from about 5 inches to about 8 inches, and the inlet of the nozzle body has a width of from about 0.5 inch to about 1 inch.

16. The nozzle assembly according to claim 12, wherein the nozzle assembly comprises two binder outlets for providing the binder to the particles of insulation material, wherein a first binder outlet is arranged at one side of the outlet of the nozzle body and a second binder outlet is arranged at the opposite side of the outlet of the nozzle body.

17. A delivery system for conveying particles of insulation material suspended in a flow of air to a substrate to form an insulation product on the substrate, comprising:
the nozzle assembly according to claim 12;
a source of particles of insulation material, and a conduit for conveying insulation particles from the source of the particles of insulation material to the inlet of the nozzle assembly;
a source of a liquid binder, and a conduit for conveying the liquid binder from the source of the liquid binder to the at least one binder outlet of the nozzle assembly.

18. A method of conveying particles of insulation material suspended in a flow of air to a substrate to form an insulation product on the substrate, comprising directing a flow of insulation particles suspended in air propelled from the nozzle assembly of claim 12 to the substrate.

19. The method according to claim 18, wherein the substrate is a wall, floor or ceiling cavity defined between adjacent elongated supporting members.

20. The method according to claim 19, further comprising a step of filling the wall, floor or ceiling cavity with the insulation material by adjusting the direction of the flow of insulation particles suspended in air, in a direction substantially parallel to the adjacent elongated supporting members which define the wall, floor or ceiling cavity.

21. The method according to claim 20, wherein the wall, floor or ceiling cavity is filled without substantially adjusting the direction of the flow of insulation particles suspended in air, in a direction perpendicular to the adjacent elongated supporting members.

22. A nozzle assembly for conveying a flow of particles of insulation material suspended in air to a substrate to form an insulation product on the substrate, comprising:
a nozzle body defining a flow path for accommodating the flow of particles of insulation material suspended in air, wherein the nozzle body comprises an inlet for receiving the flow of particles of insulation material suspended in air; and an outlet for propelling the flow from the nozzle assembly;
at least one binder outlet for providing a binder to the flow of particles of insulation material propelled from the outlet; and
a device for adjusting the profile of the outlet of the nozzle body.

23. The nozzle assembly according to claim 22, wherein the nozzle body is formed of a flexible plastic material.

24. The nozzle assembly according to claim 22, wherein the device is capable of compressing or expanding the nozzle body to adjust the profile of the outlet.

25. The nozzle assembly according to claim 22, wherein the device comprises a screw and a screw support having a threaded aperture for accommodating the screw, wherein the screw is capable of compressing or expanding the nozzle body to adjust the profile of the outlet.

26. The nozzle assembly according to claim 22, wherein the ratio of the width of the outlet to the width of the inlet is at least about 1.5:1.

27. A method of conveying particles of insulation material suspended in a flow of air to a wall, floor or ceiling cavity to form an insulation product in the cavity, comprising:
providing a flow of particles of insulation material suspended in air to the nozzle assembly of claim 22.

28. The method according to claim 27, further comprising compressing or expanding the nozzle body to adjust the profile of the outlet.

29. A method of controlling the density of a blown-in insulation product, comprising selecting (1) a distance between a nozzle assembly emitting a flow of particles of insulation material suspended in air, and a substrate on which the insulation product is formed, (2) a flow rate of the particles of insulation material, and (3) an outlet profile of the nozzle assembly, that are effective when employed together to obtain a blown-in insulation product having a thermal resistivity of from about R-3 to R-5 per inch.

30. The method according to claim 29, wherein (1), (2) and (3) are selected to minimize the density of the blown-in insulation product while maintaining the thermal resistivity of from about R-3 to R-5 per inch.

31. The method according to claim 29, wherein the blown-in insulation product has a thermal resistivity of about R-4.2 per inch.

32. The method according to claim 29, wherein the insulation product has an average density of less than about 2.5 PCF.

33. The method according to claim 32, wherein the insulation product has an average density of about 1.8 PCF.

34. A method of forming a blown-in insulation product, comprising directing a flow of particles of insulation material suspended in air emitted from a nozzle assembly at a substrate, wherein the nozzle assembly is structured such that the flow emitted therefrom forms an insulation product on the substrate having a thermal resistivity of from about R-3 to R-5 per inch, wherein the flow emitted from the nozzle assembly is effective to minimize the density of the blown-in insulation product while maintaining the thermal resistivity of from about R-3 to R-5 per inch.

35. The method according to claim 34, wherein the blown-in insulation product has a thermal resistivity of about R-4.2 per inch.

36. The method according to claim 34, wherein the insulation product has an average density of less than about 2.5 PCF.

37. The method according to claim 35, wherein the insulation product has an average density of about 1.8 PCF.
